(19) United States
(12) Patent Application Publication
(10) Pub. No.: US 2012/0154270 A1
(43) Pub. Date: Jun. 21, 2012

(54) DISPLAY DEVICE

(75) Inventor: Takaji Numao, Osaka-shi (JP)

(73) Assignee: SHARP KABUSHIKI KAISHA, Osaka-shi, Osaka (JP)

(21) Appl. No.: 13/393,230

(22) PCT Filed: May 28, 2010
(86) PCT No.: PCT/JP2010/059090

§ 371 Date: Feb. 29, 2012

(30) Foreign Application Priority Data
Sep. 29, 2009 (JP) 2009-224481

(51) Int. Cl. G09G 5/10; G09G 3/32; G06F 3/01; G09G 3/36

(52) U.S. Cl. 345/156; 345/690; 345/87; 345/77

(57) ABSTRACT

Disclosed is a display device provided with a display panel (3) that displays an image, a control panel (2) that controls directivity of light, and a visual angle detector that detects a visual angle formed by a surface of the display panel and a visual line of a viewer. The control panel controls the directivity of the light on the basis of the visual angle detected by the visual angle detector. It is possible to switch between a wide directivity and a narrow directivity, and further it is possible to change the range of the narrow directivity. By collecting light in a direction in which the viewer is present, light utilization efficiency can be improved. Further, by suppressing the amount of luminescence of a light source, a lower power consumption can be achieved.

### TECHNICAL FIELD

The present invention relates to a display device such as a liquid crystal television and an organic EL television.

### BACKGROUND ART

Recently, price reduction for liquid crystal televisions and PDP (Plasma Display Panel) televisions has proceeded and the demand for large-sized televisions have expanded. On the other hand, CO₂ reduction as a measure against the global warming is required. For this reason, energy saving is required for large-sized televisions.

As a result, a large-sized television is required to satisfy a condition of “doubling the screen size and cutting down the power consumption by half in comparison with a conventional television”. However, for achieving the object, it is required that the screen area be increased by 4 times, the power consumption be reduced by half, namely, the power consumption per unit screen area be reduced to ⅛.

For this purpose, in a light-emitting display such as PDP and an organic EL (Electro Luminescence), it is required that the luminous efficiency be increased by 8 times of a conventional display. The efficiency of a liquid crystal display is classified into a backlight efficiency and a light utilization efficiency. As the luminous efficiency of LED has been improved to about twice as that of CCFL (cold cathode fluorescent light), when the LED is used for the light source of a backlight, it will be sufficient if the light utilization efficiency is improved by about 4 times.

FIG. 10 shows main components that will impose influences on the light utilization efficiency in a typical liquid crystal display. A light radiated from a light source 101 of a backlight passes through a backlight-side polarizing plate 102, a TFT substrate 103, a liquid crystal material 104, a color filter 105 and a viewer-side polarizing plate 106 in this order before reaching the viewer's eyes.

Although the transmittance of the backlight-side polarizing plate 102 is about 40%, the light utilization efficiency can be increased to about 1.5 times by using a selective polarization-reflection plate that reflects polarized light selectively (e.g., DBEF supplied by 3M). The numerical aperture of the TFT substrate 103, which is determined by the constitution of the pixel electrode and the process condition, is about 60 to 70% at present, and predictable room for further improvement is only about 10 to 20%. The transmittance of the liquid crystal material 104 has been lowered to about 70 to 90% of a conventional material (TN mode) as a result of introduction of IPS mode or VA mode as a display mode for pursuing a high resolution. If a transmittance comparative to a previous one is obtained by changing the display mode, the transmittance can be improved by about 20%. The transmittance of the color filter 105 is about 30%, and substantially there is no room for improvement as long as RGB three colors are used. The transmittance of the viewer-side polarizing plate 106 is about 90%, and similarly there is substantially no room for improvement also for this component.

Therefore, even if all of the above-mentioned remedies were to be put into practice, the light utilization efficiency of the liquid crystal display could be doubled at most.

Due to this reason, there has been demand for a method capable of substantially doubling the light utilization efficiency, concerning any other components.

One of the method for this purpose is a field sequence color (FSC) without using a color filter 105. However, it is difficult to put this method into practice due to a problem of color breakup.

In the meantime, for a liquid crystal display or the like for a notebook PC, a method of controlling a viewing angle has been proposed for the purpose of preventing peeping of a neighbor.

A liquid crystal display device including a viewing angle controller as disclosed in Patent document 1 will be explained with reference to FIG. 11. A backlight unit 111 is disposed on the backside of a liquid crystal panel 112. The backlight unit 111 has a first prism sheet 114 having on its lower face a prism part 113, a first light guide plate 115, a second prism sheet 116 having on its lower face a prism part 113, a second light guide plate 117, and a reflection sheet 120 in this order when viewed from the liquid crystal panel 112 side. A first light source 118 emits light into the first light guide plate 115, and the second light source 119 emits light into the second light guide plate 117.

When only the first light source 118 is charged with electricity, the light exiting the first light guide plate 115 is directed to the right-above direction ‘a’ by the prism part 113 on the first prism sheet 114. Therefore, the display of the liquid crystal panel 112 becomes bright in the screen frontal direction.

When only the second light source 119 is charged with electricity, the light exiting the second guide plate 117 is directed to the right-above direction by the prism part 113 on the second prism sheet 116, and subsequently directed to the oblique directions ‘b’ and ‘c’ by the prism part 113 on the first prism sheet 114. Therefore, the display of the liquid crystal panel 112 becomes bright in the both screen oblique directions.

When both the first light source 118 and the second light source 119 are charged with electricity, due to the combination of the above-mentioned effects, the display of the liquid crystal panel 112 becomes bright in the screen frontal direction and also in the both screen oblique directions.

However, in this constitution, in a case of displaying a bright image in a screen oblique direction, the oblique direction ‘b’ and the oblique direction ‘c’ will be bright at the same time, and it is impossible to select any one of the directions.

A liquid crystal display device provided with a viewing angle controller as disclosed in Patent document 2 will be explained with reference to FIG. 12. Between a liquid crystal panel 131 and a backlight 132, a liquid crystal panel 133 for control of a viewing angle, which is provided with a hybrid-alignment liquid crystal layer 134, is arranged. When no voltage is applied between the pair of electrodes 135, 136 sandwiching the liquid crystal layer 134, the brightness of the screen of the liquid crystal panel 131 is maintained when viewed in the frontal direction, but the screen is dimmed when viewed in the lateral oblique directions (narrow viewing angle). On the other hand, when a voltage is applied between the pair of electrodes 135, 136, the hybrid alignment of the liquid crystal layer 134 collapses, and the brightness of the screen of the liquid crystal panel 131 is maintained when viewed in any of the frontal direction and the lateral oblique directions (wide viewing angle).

However, in this constitution, there is a necessity to choose only one from the narrow viewing angle and the wide viewing angle.

### PRIOR ART DOCUMENTS

### Patent Documents

Patent document 1: JP 2008-123925 A

Patent document 2: JP 2008-282051 A

Patent document 3: JP 2009-80286 A

### DISCLOSURE OF INVENTION

### Problem to be Solved by the Invention

A function of peep prevention is not required for a liquid crystal display used in a television. Rather, at a shopfront as shown in FIG. 13, since a customer 140 compares screens of a plurality of televisions 141a-141f on shelves, a television with a screen that can be viewed beautifully in all directions due to the wide viewing angle is preferred. In particular, since televisions are aligned often in vertical and horizontal directions at the shopfront, the customer 140 does not always watch the television in the frontal direction, but he/she may watch it also from the vertically and/or laterally oblique directions.

For this reason, the directivity of television should not be limited to the frontal direction but it should be expanded in lateral directions and/or vertical directions as shown in FIGS. 14A and 14B.

On the other hand, when a customer who bought the television watches the television at home, the positions of the viewers 151a-151c who watch the television 150 are limited as shown in FIGS. 15A and 15B. Therefore, a wide directivity is not required for the television 150.

In particular, in the vertical direction, as shown in FIG. 16B, the relationship between the height of the eyes of the viewer 151 and the height of the television 150 is determined by for example the height of a sofa on which the viewer 141 is seated and the height of the TV board on which the television 150 is mounted, and the relationship is fixed often in a range 154b. In such a case, light emitted from the television 150 toward the ranges 154a and 154c is wasted.

Similarly, in the horizontal direction, as shown in FIG. 16A, in a case where only the viewer 151 seated at the center of a sofa 152 watches the television 150, the light emitted toward the range 153b from the television 150 is sufficient, while light emitted toward the ranges 153a and 153c is wasted.

However, when the viewer 151 stands up and watches the television 150, there is a necessity that the light is emitted toward the range 154a in FIG. 16B, and light emitted toward the remaining ranges is wasted. When the viewer 151 sits on one edge of the sofa 152, there is a necessity that the light is emitted toward the range 153a or 153c in FIG. 16A, and light emitted toward the remaining ranges is wasted.

The light utilization efficiency is improved if the light emitted toward any unnecessary range and wasted can be emitted toward a range where the light is needed. If the improvement in the light utilization efficiency is used not to improve the screen brightness but to suppress the amount of luminescence of the backlight, the power consumption can be reduced.

The present invention aims to provide a power-saving display device by enabling switchover between a wide directivity (wide viewing angle) and a narrow directivity (narrow viewing angle) and furthermore by enabling a change of the range of the narrow directivity (or direction).

### Means for Solving Problem

A display device of the present invention is characterized in that it includes: a display panel that displays an image; a control panel that controls directivity of light; and a visual angle detector that detects a visual angle formed by a surface of the display panel and a visual line of a viewer, wherein the control panel controls the directivity of light on the basis of the visual angle detected by the visual angle detector.

### Effects of the Invention

In the display device of the present invention, a control panel controls the directivity of light and switches the emission direction. Thereby, for example it is possible to switch between a shopfront mode with a wide viewing angle, which is obtained when no directivity is provided, and a home mode with a narrow viewing angle, which is obtained when a directivity corresponding to the viewer's position is provided. Further at the home mode, since it is possible to collect light in the viewer's direction, the light utilization efficiency is improved and a lower power consumption can be achieved.

### BRIEF DESCRIPTION OF DRAWINGS

FIG. 1 is a front view showing an appearance of a liquid crystal television according to a first embodiment of the present invention.

FIG. 2 is a cross-sectional view showing a constitution of a display device of a liquid crystal television according to the first embodiment of the present invention.

FIG. 3A is a diagram showing optical paths of light passing through a first liquid crystal lens for a case of providing a vertically wide directivity in the first embodiment of the present invention.

FIG. 3B is a diagram showing optical paths of light passing through a first liquid crystal lens for a case of providing a narrow directivity directed upward in the vertical direction in the first embodiment of the present invention.

FIG. 3C is a diagram showing optical paths of light passing through a first liquid crystal lens for a case of providing a narrow directivity directed downward in the vertical direction in the first embodiment of the present invention.

FIG. 3D is a diagram showing optical paths of light passing through a first liquid crystal lens for a case of providing a narrow directivity directed frontally in the vertical direction in the first embodiment of the present invention.

FIG. 4 is a diagram for explaining an angle θe formed by light emitted into a grooved glass plate and the normal line of a flat glass plate in a first liquid crystal lens in the first embodiment of the present invention.

FIG. 5 is a diagram showing an example of optical paths of light passing through the first liquid crystal lens where the grooved glass plate is placed closer to the backlight than the flat glass plate in the first embodiment of the present invention.

FIG. 6 is a front view showing an appearance of a liquid crystal television according to a second embodiment of the present invention.

FIG. 7 is a cross-sectional view showing a constitution of a display device of a liquid crystal television according to the second embodiment of the present invention.

FIG. 8A is a diagram showing optical paths of light passing through one of a pair of sheets composing a first directive film in the second embodiment of the present invention.

FIG. 8B is a diagram showing optical paths of light passing through the other sheet of the first directive film in the second embodiment of the present invention.

FIG. 9 is a cross-sectional view showing a constitution of a display device of an organic EL television according to a third embodiment of the present invention.

FIG. 10 is a conceptual diagram showing a typical constitution of a liquid crystal display.

FIG. 11 is a cross-sectional view showing a conventional liquid crystal display device comprising a viewing angle controller.

FIG. 12 is a cross-sectional view showing another conventional liquid crystal display device comprising a viewing angle controller.

FIG. 13 is a front view showing a scene where a customer compares a plurality of televisions at a shopfront.

FIG. 14A is a top view showing a scene where a customer compares a plurality of televisions at a shopfront, and FIG. 14B is the side view.

FIG. 15A is a top view showing a viewer who watches television at home, and FIG. 15B is the side view.

FIG. 16A is a top view showing a horizontal directivity required for a television at home, and FIG. 16B is a side view for explaining a vertical directivity.

FIGS. 17A-17D are cross-sectional views showing another directive film for forming a control panel in the second embodiment of the present invention.

### DESCRIPTION OF THE INVENTION

In the above-mentioned display device of the present invention, it is preferable that the control panel controls the directivity of light in the vertical direction and in the lateral direction. Thereby, it is possible to direct light traveling in a direction where no viewer is present to a direction of a viewer, and thus the light utilization efficiency is improved further and the power consumption can be reduced.

For the method that the visual angle detector detects the direction of the viewer, i.e., the visual angle, the two methods below are preferred.

In a first method, the visual angle detector detects the visual angle on the basis of information provided by a remote-control.

In a second method, the visual angle detector detects the visual angle on the basis of a picture taken with a camera.

The first method has an advantage that visual angle information can be obtained at a low cost. On the other hand, visual angle information cannot be obtained unless the viewer operates the remote-control.

The second method has an advantage that visual angle information can be obtained without any particular operation by the viewer. On the other hand, a camera for taking a picture including the viewer is necessary, and that image-identification software for analyzing the picture and extracting the viewer from the background is necessary, thereby the cost is increased.

For the control panel, the following two constitutions are preferred.

In a first constitution, the control panel is formed of a liquid crystal lens. The directivity is controlled by changing voltage applied to the liquid crystal forming the liquid crystal lens.

In a second constitution, the control panel is formed of a plurality of directive films. The directivity is controlled by changing the combination of the directive films.

The first constitution has an advantage that since the directivity is controlled by a voltage application, no mechanical unit is included and the life can be extended. On the other hand, since there is a necessity of forming a patterned electrode, cost reduction is difficult.

The second constitution has an advantage that since a plurality of films are switched in use, a patterned electrode is unnecessary, and the cost can be reduced easily. On the other hand, due to the necessity of moving the film, the second constitution needs a mechanical unit and thus may be broken easily.

For the display panel, the following constitutions are preferred.

In a first constitution, a liquid crystal panel is used for the display panel. In this constitution, the control panel can be placed between the liquid crystal panel and the backlight, or may be placed closer to the front side (viewer side) than the liquid crystal panel.

In a second constitution, a light-emitting panel is used for the display panel. An organic EL panel is preferred particularly. In this constitution, the control panel is placed closer to the front side (viewer side) than the light-emitting panel.

Hereinafter, preferred embodiments of the present invention will be described with reference to the attached drawings. It should be noted that the present invention is not limited to the following embodiments. The respective drawings referred to in the explanation below illustrate only the main components necessary for explanation of the present invention in a simple manner. Therefore, the present invention can be provided with any arbitrary components not shown in the drawings. The dimensions of the components in the respective drawings may not represent the actual dimensions of the components or the proportions in dimensions of the respective components.

### First Embodiment

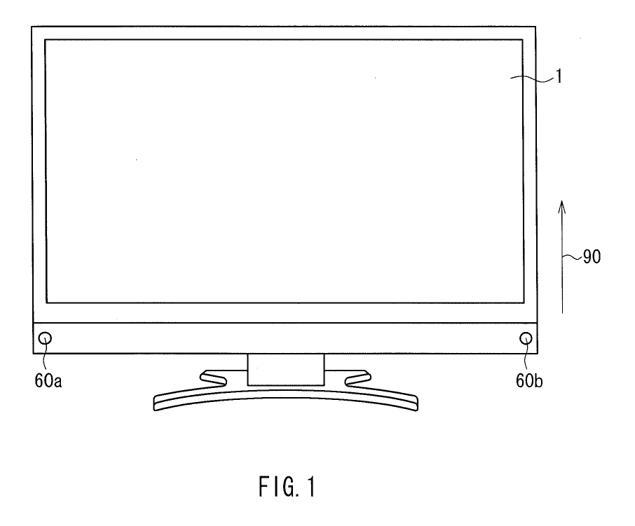

FIG. 1 is a front view showing an appearance of a liquid crystal television according to a first embodiment of the present invention. This liquid crystal television has two infrared receiving units 60a, 60b and a display device 1. An arrow 90 indicates the upward direction.

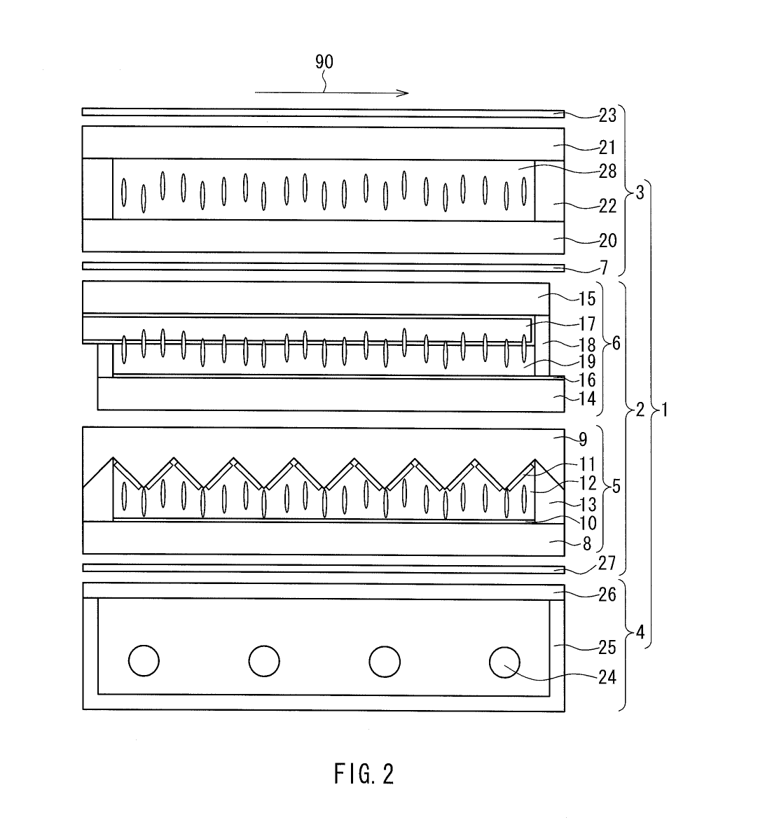

As shown in FIG. 2, the display device 1 includes a liquid crystal panel 3 for display, a control panel 2 and a backlight 4. In FIG. 2, the lateral direction of the paper sheet indicates the vertical direction of the liquid crystal television and the arrow 90 indicates the upward direction.

The backlight 4 is formed of a light source 24 including CCFL, LED or the like, a cabinet 25 and a scattering plate 26 provided at the opening of the cabinet 25 facing the control panel 2.

The liquid crystal panel 3 for display is formed of a TFT substrate 20, a counter substrate 21, a liquid crystal 28 sandwiched therebetween, and a sealant 22 that seals the liquid crystal 28. Polarizing plate 7 is placed closer to the backlight 4 than the TFT substrate 20 and a polarizing plate 23 is placed closer to an observer than the counter substrate 21. Though not shown, active elements such as a thin film transistor (TFT) and a wiring for driving the same, a pixel electrode for applying a voltage to the liquid crystal 28 and the like are formed in a known manner on a surface of the TFT substrate 20 so as to face the liquid crystal 28, and an alignment film is formed further to cover these components. Furthermore, though not shown, a color filter, a common electrode and an alignment film are formed in this order on a surface of the counter substrate 21 so as to face the liquid crystal 28.

In the present embodiment, a liquid crystal lens is placed as a control panel 2 between the liquid crystal panel 3 and the backlight 4. This liquid crystal lens is composed of a first liquid crystal lens 5 that controls the vertical directivity and a second liquid crystal lens 6 that controls the lateral directivity.

The liquid crystal lenses 5, 6 respectively are formed of: flat glass plates 8, 14; grooved glass plates 9, 15; liquid crystals 12, 19 sandwiched therebetween; and sealants 13, 18 that seal the liquid crystals 12, 19. Flat electrodes 10, 16 and alignment films (not shown) are formed in this order on the surfaces of the flat glass plates 8, 14 so as to face the liquid crystals 12, 19, so that each of the flat electrodes and alignment films is placed continuously on the entire region opposing the active area (an area where effective pixels are present) of the liquid crystal panel 3. A large number of grooves having cross sections like isosceles triangles arranged at equal pitches are formed on the surfaces of the grooved glass plates 9, 15 opposing the liquid crystals 12 and 19. Strip-shaped chevron electrodes 11, 17 are formed independently from each other on each inclined surface corresponding to the hypotenuse of the isosceles triangles. Furthermore, alignment films (not shown) are formed on the surfaces of the grooved glass plates 9, 15 so as to face the liquid crystals 12, 19 for the purpose of covering the chevron electrodes 11, 17. The grooves formed on the grooved glass plate 9 forming the first liquid crystal lens 5 and the strip-shaped chevron electrodes 11 extend in parallel to the horizontal direction, and the grooves formed on the grooved glass plate 15 forming the second liquid crystal lens 6 and the strip-shaped chevron electrodes 17 extend in parallel to the vertical direction. The flat electrodes 10, 16 and the chevron electrodes 11, 17 have translucency, and they can be formed by using ITO (Indium Tin Oxide) for example.

In FIG. 2, a driving circuit, which drives the liquid crystal panel 3 for display, the liquid crystal lenses 5, 6 and the light source 24, is not shown. The reference number 27 denotes a selective polarization-reflection plate, which may be placed between the polarizing plate 7 at the backlight side and the control panel 2.

The grooved glass plates 9, 15 provided with the chevron electrodes 11, 17 can be formed for example in the following manner.

First, on one surface of a flat glass plate, stripe-shaped resists are formed at positions to form ridges (apices of adjacent inclined surfaces) of the grooved glass plates 9, 15. Next, the flat glass plate is wet-etched by using this resist as a mask. Utilizing an under-etching caused by the etching solution entering the bottom of the resist, a groove having an inclined surface can be formed. Later, the resist is removed to obtain the grooved glass plates 9, 15. Then, on the whole surface having the grooves of each of the grooved glass plates 9, 15, a thin film of an electrode material such as ITO is formed by sputtering. Next, a stripe-shaped resist is formed on this thin film and the thin film is dry-etched, thereby forming the chevron electrodes 11, 17 independent from each other. Subsequently, the resist is removed, and an alignment film material such as polyimide is applied with a roller so as to form an alignment film.

In an alternative method for forming the grooved glass plates 9, 15, the grooves of the grooved glass plates 9, 15 can be transferred by using a mold. For example, a resin (for example, a thermoplastic resin or a thermosetting resin) is applied on one surface of the flat glass plate, which is then covered with a mold having the groove shape of the grooved glass plates 9, 15 and cured, thereby the groove shape is transferred onto the resin surface. The mold can be prepared by using super-hard materials such as nickel, nickel-phosphor, anoxic steel, and tungsten carbide (WC), on which grooves are formed by a method such as cutting and a process to use focused ion beams.

A liquid crystal television according to the present embodiment includes a visual angle detector that detects a visual angle formed by the surface of a display device 1 (i.e., liquid crystal panel 3 for display) and a visual line of a viewer. The visual angle detector detects the vertical and horizontal visual angles on the basis of information provided by a remote-control of the liquid crystal television. And the control panel 2 controls the vertical and horizontal directivities of light on the basis of the visual angle detected by the visual angle detector so that the viewing angle is provided in the visual angle direction.

Specifically, an infrared signal emitted at the time the viewer operates horizontal (lateral) and vertical visual angle adjustment buttons provided on the remote-control is received by the infrared receiving units 60a and 60b so as to detect the horizontal and vertical visual angles, thereby adjusting the directivity of light. Furthermore, for the horizontal direction, the infrared signal emitted by the remote-control is received by the infrared receiving units 60a, 60b so as to detect the horizontal position of the remote-control, and the horizontal visual angle is detected assuming that the viewer is present in the direction where the remote-control is positioned, thereby the horizontal directivity of light is re-adjusted.

It should be noted that the method for detecting the visual angle is not limited to the above-described example. For example, it is also possible to dispose two infrared receiving units separated from each other in the vertical direction, so that these two infrared receiving units receive infrared signals emitted by the remote-control so as to detect the vertical visual angle. Alternatively, it is possible to detect the visual angle only through operation with the horizontal (lateral) and vertical visual angle adjustment buttons provided on the remote-control while only one infrared receiving unit is disposed. Alternatively, as mentioned in the second embodiment below, it is possible to detect the visual angle by recognizing the viewer's position from the picture taken with a camera.

The directivity of light (i.e., viewing angle) is controlled by the first liquid crystal lens 5 in the vertical direction and by the second liquid crystal lens 6 in the horizontal direction.

The mechanism for the liquid crystal lenses 5 and 6 to control the directivity will be explained below.

A scattering plate 26 on the backlight 4 is set to scatter light in all directions, and the liquid crystal lenses 5, 6 are set to condense the scattered light. Although the basic constitutions of the liquid crystal lens 5 and the liquid crystal lens 6 are identical, since the optical systems are rotational symmetry of 90° when viewed from the front, they are different from each other in that the direction of controlling the directivity of light is horizontal or vertical. Hereinafter, the liquid crystal lens 5 will be explained. The same explanation is applied to the liquid crystal lens 6.

For the liquid crystal 12, for example, a liquid crystal whose refractive index n1 in the short axis direction is 1.5 (for example MBBA or the like) is used. For the flat glass plate 8 and the grooved glass plate 9, an optical glass (for example, BK-7 or the like) having a refractive index ng of 1.51 that is approximate to the refractive index n1 in the short axis direction of the liquid crystal 12 is used.

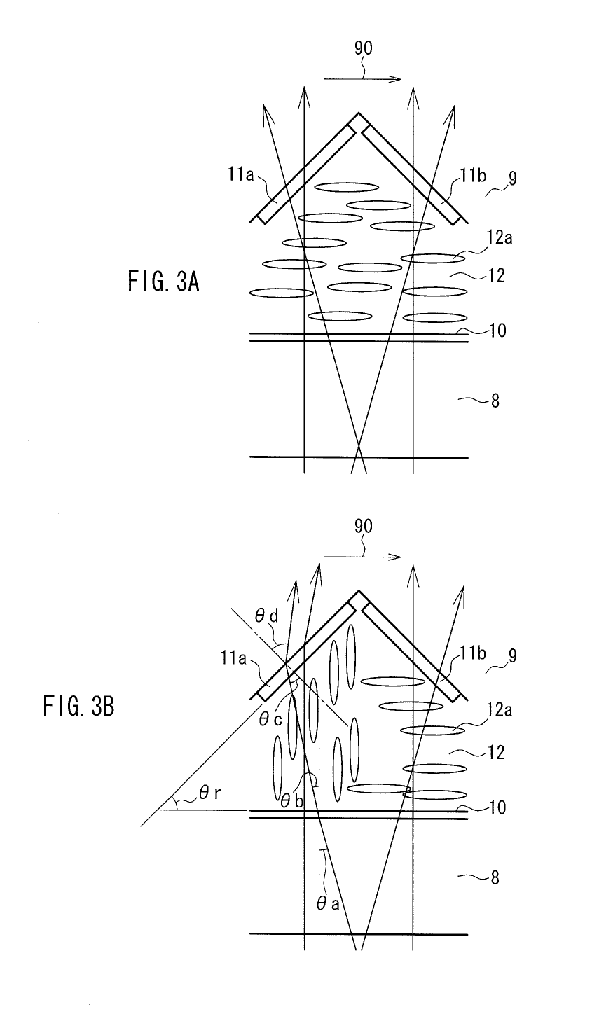

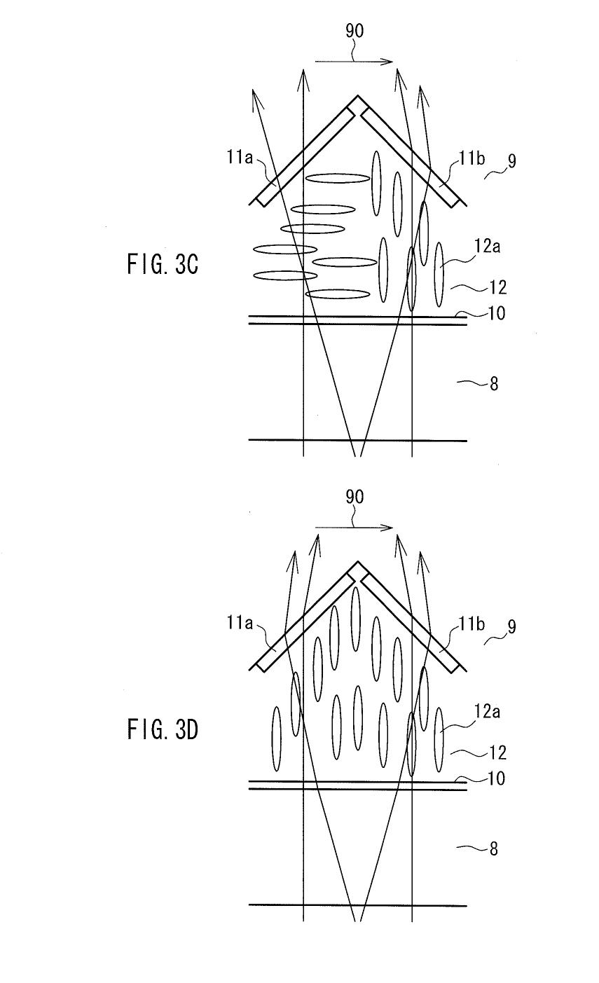

Since the dielectric anisotropy Δε of MBBA is negative, as shown in FIG. 3A, when a voltage is applied between the flat electrode 10 and the chevron electrodes 11a, 11b, the liquid crystal molecules 12a lie along the flat glass plate 8. At this time, light entering through the flat glass plate 8 passes directly through the liquid crystal lens 5 since the refractive index of the glass plates 8, 9 is equal to that of the liquid crystal 12. As a result, a wide directivity is obtained.

On the other hand, when no voltage is applied between the flat electrode 10 and the chevron electrode 11a, as shown in FIG. 3B, the liquid crystal molecules 12a present between the flat electrode 10 and the chevron electrode 11a stand orthogonally to the flat glass plate, since a perpendicularly alignment film is formed on the flat electrode 10. The refractive index n2 in the long axis direction of the liquid crystal 12 is 1.83. When the voltage of the flat electrode 10 is equal to that of the chevron electrode 11a, the incident angle θa and the emission angle (refractive angle) θb of light entering the liquid crystal 12 from the flat glass plate 8 satisfy Equation (1) below.

ng×sin θa=n2×sin θb (1)

The Equation (1) is transformed to Equation (2), and the emission angle θb is given in Equation (3).

sin θb=(ng/n2)×sin θa (2)

θb=sin⁻¹((ng/n2)×sin θa) (3)

When an angle at which this light enters the chevron electrode 11a is set to θc and an angle formed by the chevron electrode 11a and the flat glass plate 8 is set to θr, Equation (4) below is established.

θr+(90−θc)+(90−θb)=180 (4)

Therefore, the incident angle θc is given in Equation (5) below.

θc=θr−θb (5)

The incident angle θc and the emission angle (refractive angle) θd of light entering the grooved glass plate 9 from the liquid crystal 12 satisfy Equation (6) below.

n2×sin θc=ng×sin θd (6)

The Equation (6) is transformed to Equation (7), and the emission angle θd is given in Equation (8).

sin θd=(n2/ng)×sin θc (7)

θd=sin⁻¹((n2/ng)×sin θc) (8)

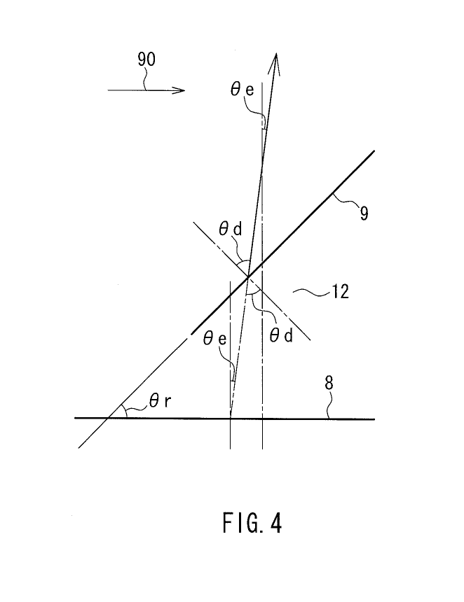

When an angle formed by the light having the emission angle θd and the normal line of the flat glass plate 8 is set to θe, Equation (9) below is established from FIG. 4.

θr+(90−θd)+(90+θe)=180 (9)

Therefore, the angle θe is given in Equation (10) below.

θe=θd−θr (10)

Table 1 shows the changes of the angles θb, θc, θd and θd accompanying the change in the incident angle θa when θr=45°.

TABLE 1

| θa | θb | θr | θc | θd | −θe |
|---|---|---|---|---|---|
| 0 | 0.00 | 45 | 45.00 | 58.98 | −13.98 |
| 5 | 4.12 | 45 | 40.88 | 52.48 | −7.48 |
| 10 | 8.24 | 45 | 36.76 | 46.50 | −1.50 |
| 15 | 12.33 | 45 | 32.67 | 40.86 | 4.14 |
| 20 | 16.39 | 45 | 28.61 | 35.47 | 9.53 |
| 25 | 20.41 | 45 | 24.59 | 30.29 | 14.71 |
| 30 | 24.37 | 45 | 20.63 | 25.28 | 19.72 |
| 35 | 28.25 | 45 | 16.75 | 20.45 | 24.55 |
| 40 | 32.03 | 45 | 12.97 | 15.78 | 29.22 |
| 45 | 35.69 | 45 | 9.31 | 11.30 | 33.70 |
| 50 | 39.20 | 45 | 5.80 | 7.03 | 37.97 |
| 55 | 42.53 | 45 | 2.47 | 3.00 | 42.00 |
| 60 | 45.61 | 45 | −0.61 | −0.74 | 45.74 |
| 65 | 48.40 | 45 | −3.40 | −4.12 | 49.12 |
| 70 | 50.84 | 45 | −5.84 | −7.08 | 52.08 |
| 75 | 52.85 | 45 | −7.85 | −9.52 | 54.52 |
| 80 | 54.35 | 45 | −9.35 | −11.36 | 56.36 |
| 85 | 55.29 | 45 | −10.29 | −12.50 | 57.50 |
| 90 | 55.60 | 45 | −10.60 | −12.88 | 57.88 |

Table 1 shows that when θr=45°, light that has entered the liquid crystal 12 from the flat glass plate 8 at an incident angle of 60° exit toward the emission surface side of the grooved glass plate 9 at an angle θe of about 45°.

As mentioned above, by equalizing the voltage of the chevron electrode 11a to the voltage of the flat electrode 10, light traveling downward from the backlight 4 can be directed upward (or toward the center). As a result, by decreasing light that travels downward and increasing light that travels upward, a narrow directivity directed upward can be obtained.

FIG. 3C shows the arrangement of liquid crystal molecules 12a and the optical paths of light passing through the liquid crystal 12 during no voltage is applied between the flat electrode 10 and the chevron electrode 11b. At this time, the liquid crystal molecules 12a present between the flat electrode 10 and the chevron electrode 11b stand orthogonally with respect to the flat glass plate. Therefore, to the contrary to the case of FIG. 3B, the light traveling upward from the backlight 4 can be directed downward (or toward the center). As a result, by decreasing light that travels upward and increasing light that travels downward, a narrow directivity directed downward can be obtained.

FIG. 3D shows the arrangement of liquid crystal molecules 12a and the optical paths of light passing through the liquid crystal 12 during no voltage is applied between the flat electrode 10 and the chevron electrodes 11a, 11b. At this time, the liquid crystal molecules 12a present between the flat electrode 10 and the chevron electrodes 11a, 11b stand orthogonally with respect to the flat glass plate. Therefore, light traveling downward from the backlight 4 can be directed upward (or toward the center) and light traveling upward from the backlight 4 can be directed downward (or toward the center). As a result, by decreasing light that travels upward and downward and increasing light that travels toward the center, a narrow directivity directed to the center (frontal direction) can be obtained.

In this manner, it is possible to control the directivity (viewing angle) of light in the vertical direction by use of the first liquid crystal lens 5.

Though not explained in detail, the voltage applied to the liquid crystal 19 of the second liquid crystal lens 6 is controlled similarly to the first liquid crystal lens 5 as mentioned in FIGS. 3A-3D, so that the directivity (viewing angle) of light in the horizontal direction can be controlled similarly.

As mentioned above, in the liquid crystal television according to the first embodiment, it is possible to switch a wide directivity (wide viewing angle) required at the shopfront for example and a narrow directivity (narrow viewing angle) required at home for example, and furthermore, it is possible to change the range of the narrow directivity (or the direction) in accordance with the visual angle of a detected viewer. When a narrow directivity is selected, since the control panel 2 directs light emitted from the backlight 4 in an unnecessary direction to travel in a required direction, the light utilization efficiency is improved and the brightness of the screen is improved. If the amount of luminescence of the light source 24 of the backlight 4 is decreased instead of improving the brightness of the screen, lower power consumption can be achieved.

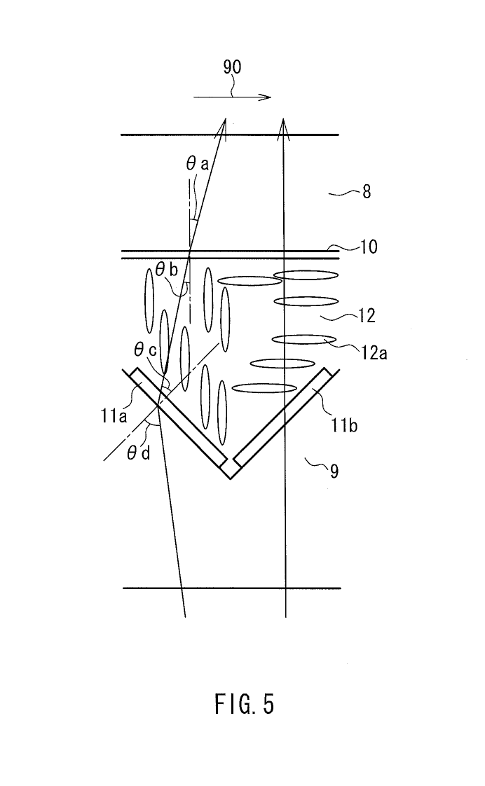

In the above explanation, in the first and second liquid crystal lenses 5 and 6, the flat glass plates 8, 14 are placed closer to the backlight 4 than the grooved glass plates 9, 15. Alternatively, it is possible to reverse the first and second liquid crystal lenses 5, 6 so that the grooved glass plates 9, 15 will be placed closer to the backlight 4 than the flat glass plates 8, 14. FIG. 5 shows an example of optical paths in the thus reversed first liquid crystal lens 5. Angles θa, θb, θc, θd in FIG. 5 corresponds respectively to the angles θa, θb, θc, θd in FIG. 3B. As clearly shown in FIG. 5, even if the first and second liquid crystal lenses 5, 6 are reversed, the light can be refracted similarly as having been explained with reference to FIGS. 3A-3D, and thus the same effect can be obtained.

It is also possible to exchange the positions of the first liquid crystal lens 5 and the second liquid crystal lens 6, and similarly an effect as described above can be obtained.

In the above-mentioned embodiment, the control panel 2 is placed between the liquid crystal panel 3 and the backlight 4. Alternatively, the control panel 2 can be placed closer to the viewer than the liquid crystal panel 3.

### Second Embodiment

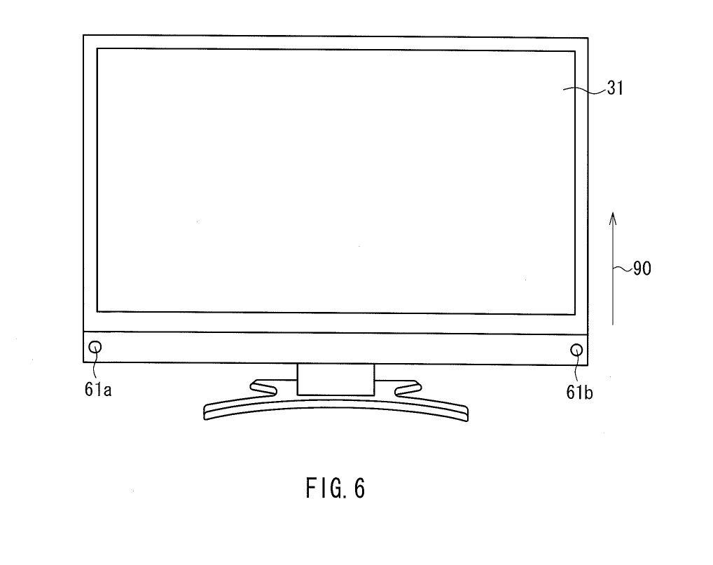

FIG. 6 is a front view showing an appearance of a liquid crystal television according to a second embodiment of the present invention. This liquid crystal television includes two CCD cameras 61a, 61b and a display device 31. An arrow 90 indicates the upward direction.

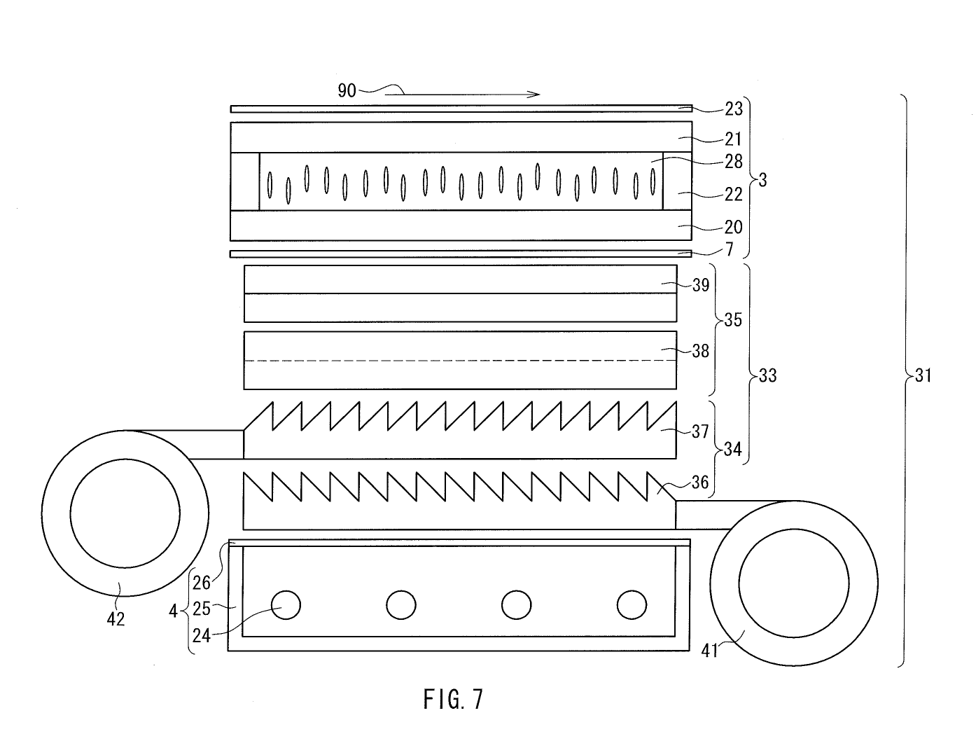

As shown in FIG. 7, the display device 31 is formed of a liquid crystal panel 3 for display, a control panel 33 and a backlight 4. In FIG. 7, the lateral direction of the paper sheet indicates the vertical direction of the liquid crystal television and the arrow 90 indicates the upward direction. In FIG. 7, components common to those of the display device 1 in FIG. 2 for the first embodiment are assigned with the same reference numbers.

As the liquid crystal panel 3 for display and the backlight 4 have constitutions substantially identical to those in the first embodiment, the components are not explained here.

In the present embodiment, sheets 36-39 are placed as the control panel 33 between the liquid crystal panel 3 and the backlight 4. On one surface of each of the sheets 36-39 facing the liquid crystal panel 3 for display, a large number of grooves having sawtooth cross sections are formed at equal pitches. A pair of sheets 36, 37 compose a first directive film 34 that controls the vertical directivity. A pair of sheets 38, 39 compose a second directive film 35 that controls the lateral directivity.

The grooves formed on the sheets 36, 37 composing the first directive film 34 extend in parallel to the horizontal direction. The saw-teeth of the sheet 36 are directed oppositely to those of the sheet 37.

The grooves formed on the sheets 38, 39 composing the second directive film 35 extend in parallel to the vertical direction. Though not shown, similarly to the case of sheets 36 and 37, the saw-teeth of the sheet 38 are directed oppositely to those of the sheet 39.

The sheets 36-39 can be formed of a flexible resin such as vinyl chloride, for example.

The upper edge of the sheet 36 is connected to a roller 41, and thus by rotating the roller 41, the sheet 36 is wound out from the roller 41 or wound into the roller 41 so as to be put in or out between the liquid crystal panel 3 and the backlight 4. Similarly, the lower edge of the sheet 37 is connected to a roller 42, and thus by rotating the roller 42, the sheet 37 is wound out from the roller 42 or wound into the roller 42 so as to be put in or out between the liquid crystal panel 3 and the backlight 4. Though not shown, one horizontal edge of each of the sheets 38, 39 is connected respectively to a roller, and thus by rotating each of the rollers, the sheets 38, 39 can be put in or out between the liquid crystal panel 3 and the backlight 4.

A liquid crystal television according to the present embodiment includes a visual angle detector that detects a visual angle formed by a surface of a display device 31 (i.e., liquid crystal panel 3 for display) and a visual line of a viewer. The visual angle detector analyzes pictures taken with the CCD cameras 61a, 61b and recognizes the viewer's position, thereby detecting the horizontal and vertical visual angles. And the control panel 2 controls the horizontal and vertical directivities of light on the basis of the visual angle detected by the visual angle detector so that the viewing angle is provided in the visual angle directions.

The method for detecting the visual angle is not limited to the above example. It is also possible to employ a method of using a viewing angle adjustment buttons of a remote-control and a method of receiving infrared signals emitted by a remote-control at a plurality of infrared receiving units so as to detect the position of the remote-control, both of which have been explained in the first embodiment.

The directivity of light (i.e., viewing angle) is controlled by the first directive film 34 in the vertical direction and by the second directive film 35 in the horizontal direction.

The mechanism for the first and second directive films 34, 35 to control the directivity will be explained below.

A scattering plate 26 on the backlight 4 is set to scatter light in all directions, and the first and second directive films 34, 35 are set to condense the scattered light. Although the basic constitutions of the first directive film 34 and the second directive film 35 are the same, since the optical systems are rotational symmetry of 90° when viewed from the front, they are different from each other in that the direction of controlling the directivity of light is horizontal or vertical. Hereinafter, the first directive film 34 will be explained. The same explanation is applied to the second directive film 35.

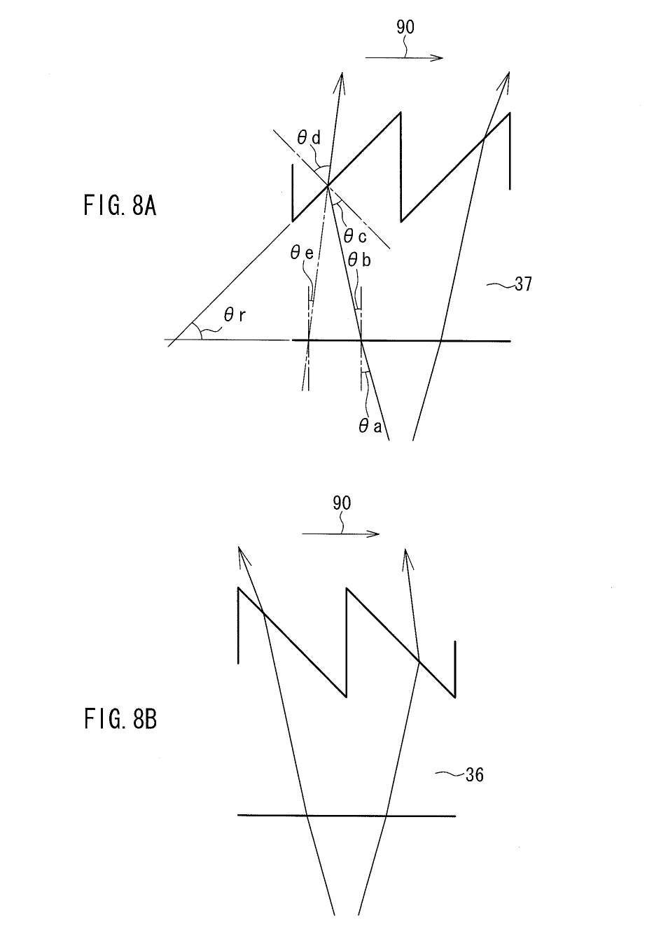

As shown in FIG. 8A, the incident angle θa and the refractive angle θb of light that has entered the lower surface of the sheet 37 from the backlight 4 side satisfy Equation (11) below. It should be noted that ‘na’ denoting a refractive index of air is about 1.0. ‘nf’ denotes a refractive index of the sheet 37. Here, for the material of the sheet 37, vinyl chloride resin having a refractive index of 1.54 is used.

na×sin θa=nf×sin θb (11)

Equation (11) is transformed to Equation (12), and the emission angle θb is given in Equation (13).

sin θb=(na/nf)×sin θa (12)

θb=sin⁻¹((na/nf)×sin θa) (13)

When an angle at which this light enters an inclined surface of a groove having a sawtooth cross section formed on the upper surface of the sheet 37 is set to θc and an angle formed by the inclined surface and the lower surface of the sheet 37 is set to θr, Equation (14) below is established.

θr+(90−θc)+(90−θb)=180 (14)

Therefore, the incident angle θc is given in Equation (15) below.

θc=θr−θb (15)

The incident angle θc and the emission angle (refractive angle) θd of light that has entered the inclined surface of the upper surface of the sheet 37 satisfy Equation (16) below.

nf×sin θc=na×sin θd (16)

Equation (16) is transformed to Equation (17), and the emission angle θd is given in Equation (18).

sin θd=(nf/na)×sin θc (17)

θd=sin⁻¹((nf/na)×sin θc) (18)

When an angle formed by the light having the emission angle θd and the normal line of the lower surface of the sheet 37 is set to θe, Equation (19) below is established.

θr+(90−θd)+(90−θe)=180 (19)

Therefore, the angle θe is given in Equation (20) below.

θe=θr−θd (20)

Table 2 shows the changes of the angles θb, θc, θd and θe accompanying the change in the incident angle θa when θr=30°.

TABLE 2

| θa | θb | θr | θc | θd | θe |
|---|---|---|---|---|---|
| 0 | 0.00 | 30 | 30.00 | 50.35 | −20.35 |
| 5 | 3.24 | 30 | 26.76 | 43.89 | −13.89 |
| 10 | 6.47 | 30 | 23.53 | 37.93 | −7.93 |
| 15 | 9.68 | 30 | 20.32 | 32.34 | −2.34 |
| 20 | 12.83 | 30 | 17.17 | 27.04 | 2.96 |
| 25 | 15.93 | 30 | 14.07 | 21.99 | 8.01 |
| 30 | 18.95 | 30 | 11.05 | 17.17 | 12.83 |
| 35 | 21.87 | 30 | 8.13 | 12.58 | 17.42 |
| 40 | 24.67 | 30 | 5.33 | 8.22 | 21.78 |
| 45 | 27.33 | 30 | 2.67 | 4.11 | 25.89 |
| 50 | 29.83 | 30 | 0.17 | 0.26 | 29.74 |
| 55 | 32.14 | 30 | −2.14 | −3.29 | 33.29 |
| 60 | 34.22 | 30 | −4.22 | −6.50 | 36.50 |
| 65 | 36.05 | 30 | −6.05 | −9.34 | 39.34 |
| 70 | 37.60 | 30 | −7.60 | −11.76 | 41.76 |
| 75 | 38.85 | 30 | −8.85 | −13.70 | 43.70 |
| 80 | 39.75 | 30 | −9.75 | −15.12 | 45.12 |
| 85 | 40.31 | 30 | −10.31 | −15.99 | 45.99 |
| 90 | 40.49 | 30 | −10.49 | −16.29 | 46.29 |

Table 2 shows that when θr=30°, light that has entered the lower surface of the sheet 37 from the backlight 4 at an incident angle of 60° exit the inclined surface of the upper surface of the sheet 37 at an angle θe of about 36°.

As mentioned above, by rotating the roller 42 so as to place the sheet 37 between the backlight 4 and the liquid crystal panel 3, light traveling downward from the backlight 4 can be directed upward. As a result, by decreasing light that travels downward and increasing light that travels upward, a narrow directivity directed upward can be obtained.

FIG. 8B shows the optical paths of the light passing through the sheet 36. The saw-teeth formed on the upper surface of the sheet 36 are opposite to those of the sheet 37. Therefore, by rotating the roller 41 so as to place the sheet 36 between the backlight 4 and the liquid crystal panel 3, to the contrary to the case of FIG. 8A, the light traveling upward from the backlight 4 can be directed downward. As a result, by decreasing light that travels upward and increasing light that travels downward, a narrow directivity directed downward can be obtained.

Though not shown in the drawings, if both the sheet 36 and the sheet 37 are placed between the backlight 4 and the liquid crystal panel 3, the light traveling downward from the backlight 4 can be directed upward, and the light traveling upward from the backlight 4 can be directed downward. As a result, by decreasing light that travels upward and downward and increasing light that travels toward the center, a narrow directivity directed to the center (frontal direction) can be obtained.

Though not shown in the drawings, if neither the sheet 36 or the sheet 37 is placed between the backlight 4 and the liquid crystal panel 3, the light emitted from the backlight 4 travels directly, and thus a wide directivity is obtained.

As mentioned above, it is possible to control the directivity of light (viewing angle) in the vertical direction by using the first directive film 34 composed of a pair of sheets 36, 37.

Though a detailed explanation is omitted here, if the sheet 39 is placed between the backlight 4 and the liquid crystal panel 3, the light traveling to the left can be directed to the right. If the sheet 38 is placed between the backlight 4 and the liquid crystal panel 3, the light traveling to the right can be directed to the left. Therefore, similarly to the above-mentioned case of the sheets 36 and 37, it is possible to control the directivity of light (viewing angle) in the horizontal direction by placing or not the sheets 38 and 39 composing the second directive film 35 between the backlight 4 and the liquid crystal panel 3.

As mentioned above, in the liquid crystal television according to the second embodiment, it is possible to switch a wide directivity (wide viewing angle) required at the shopfront for example and a narrow directivity (narrow viewing angle) required at home for example, and furthermore, it is possible to change the range of the narrow directivity (or the direction) in accordance with the visual angle of a detected viewer. When a narrow directivity is selected, since the control panel 33 directs light emitted from the backlight 4 in an unnecessary direction to travel in a required direction, the light utilization efficiency is improved and the brightness of the screen is improved. If the amount of luminescence of the light source 24 of the backlight 4 is decreased instead of improving the brightness of the screen, lower power consumption can be achieved.

Alternatively, the first and second directive films 34, 35 may be reversed so that the surface of the sheets 36-39 on which the sawtooth grooves have been formed will face the backlight 4. In this case, it is possible to refract light similarly to the above explanation, and thus the same effect can be obtained.

Alternatively, the positions of the sheet 36 and the sheet 37 may be exchanged, or the positions of the sheet 38 and the sheet 39 may be exchanged. In any case, the effects similar to those explained above can be obtained. Further, the positions of the first directive film 34 and the second directive film 35 may be exchanged. Similarly in this case, the effects similar to those explained above can be obtained.

The material of the sheets 36-39 is not limited to the above-mentioned vinyl chloride resin, but it can be replaced by any of other resins or a materials other than resin.

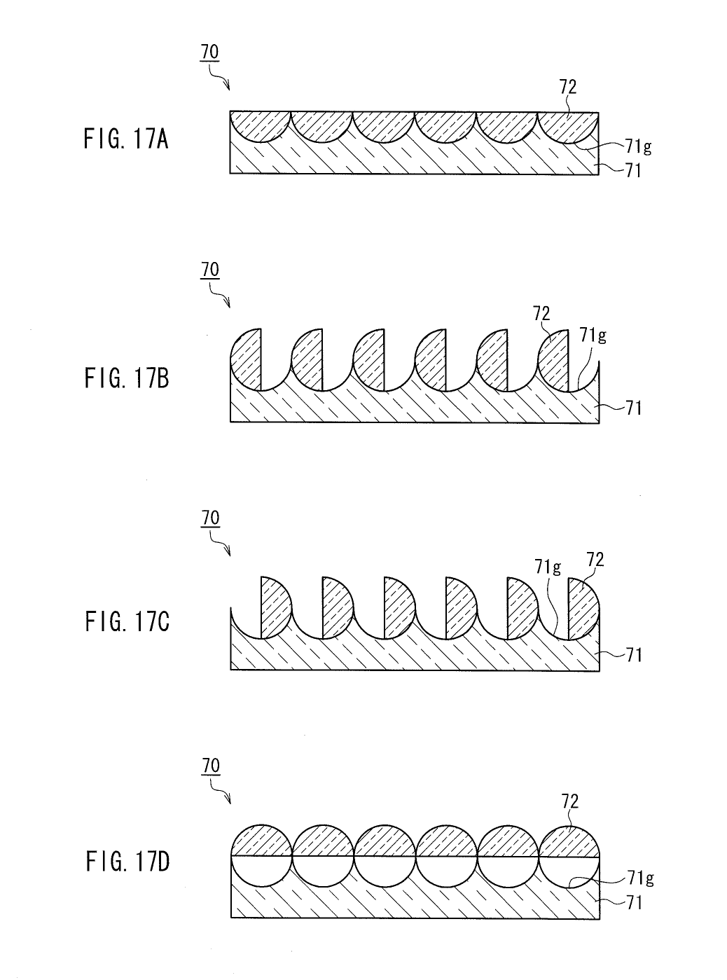

The directive films 34 and 35 in the above embodiment are formed by using the sheets 36-39 on which sawtooth grooves have been formed, but the present invention is not limited to this constitution. For example, a directive film 70 as shown in FIGS. 17A-17D can be used. This directive film 70 includes a substrate 71 having a plurality of semi-cylindrical grooves 71g that have been formed in parallel and adjacent to each other on one surface of the substrate, and a plurality of semicircular columns 72 corresponding one-to-one to the plural grooves 71g. The radius of the cylindrical surface of the periphery of the semicircular columns 72 is equal to the radius of the semi-cylindrical surface of each groove 71g. The plural semicircular columns 72 can rotate about the central axis synchronously as shown in FIGS. 17A-17D.

In the display device as shown in FIG. 7, instead of the first directive film 34, the directive film 70 is placed between the liquid crystal panel 3 and the backlight 4 so that the longitudinal direction of the grooves 71g will be horizontal. Further, instead of the second directive film 35, the directive film 70 is placed between the liquid crystal panel 3 and the backlight 4 so that the longitudinal direction of the grooves 71g will be vertical. A pair of directive films 70 placed in this manner constitute the control panel 33. Alternatively, it is possible to remove the scattering plate 26 so as to allow a substantially parallel light to enter the pair of directive films 70 from the backlight 4.

As shown in FIG. 17A, in a case where the semicircular columns 72 are contained in the grooves 71a, the directive film 70 can be regarded as a substantially parallel plate, and thus a narrow directivity directed to the center (frontal direction) can be obtained.

As shown in FIGS. 17B and 17C, in a case where the halves of the semicircular columns 72 are contained in the grooves 71a, a narrow directivity directed to right/left as shown in FIGS. 17B and 17C can be obtained. In comparison between FIGS. 17B and 17C, the directivities are inversed from each other.

As shown in FIG. 17D, in a case where the semicircular columns 72 have been pulled out from the grooves 71g, light is refracted on each of cylindrical surfaces of the grooves 71g and the semicircular columns 72, thereby a wide directivity can be obtained.

Therefore, by controlling independently the phases (postures) of the plural semicircular columns 72 composing each of the pair of directive films 70, it is possible to control the directivity of light in the vertical direction and also the directivity of light in the horizontal direction (viewing angle).

Though the control panel 33 is placed between the liquid crystal panel 3 and the backlight 4 in the above embodiment, alternatively, the liquid crystal panel 33 may be placed closer to the viewer than the liquid crystal panel 3.

### Third Embodiment

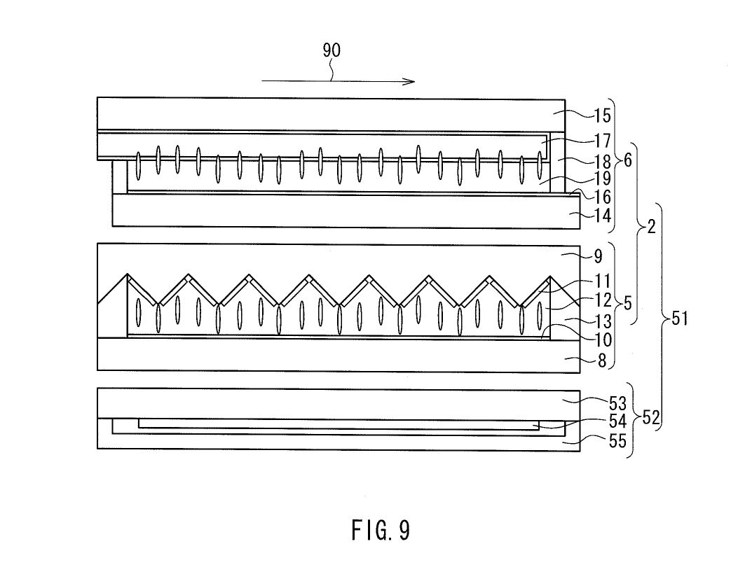

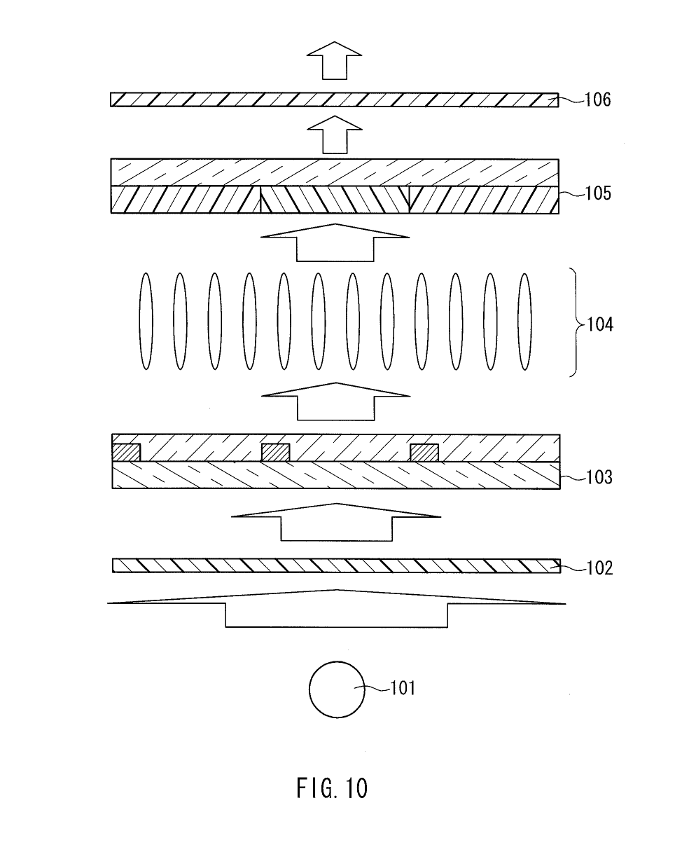

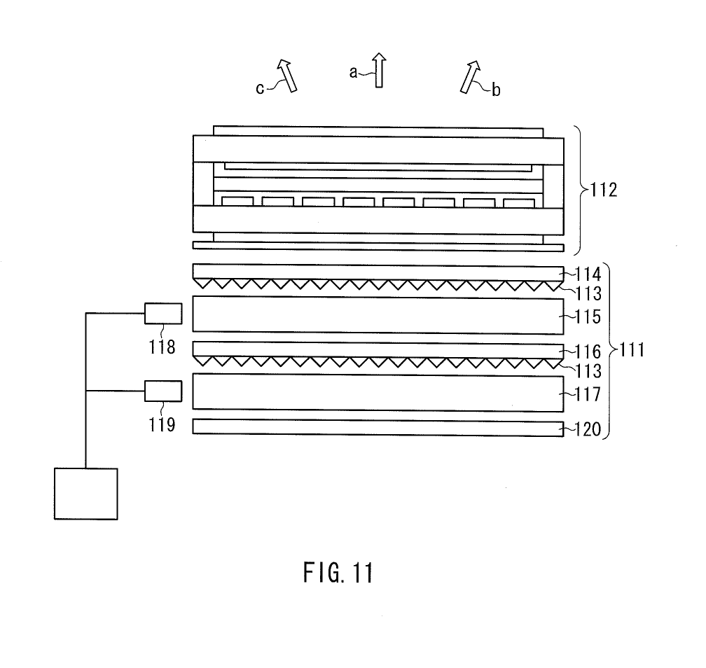

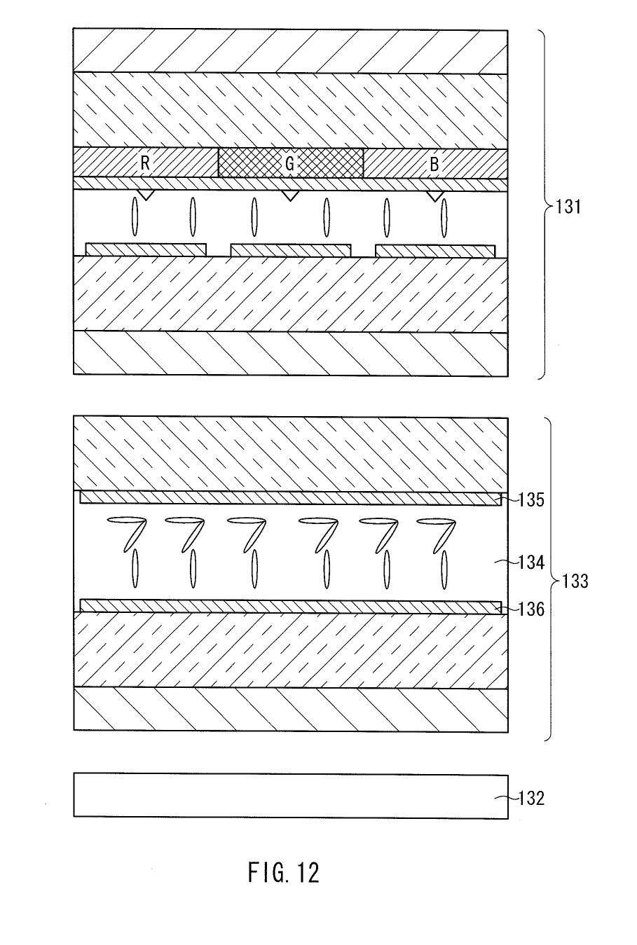

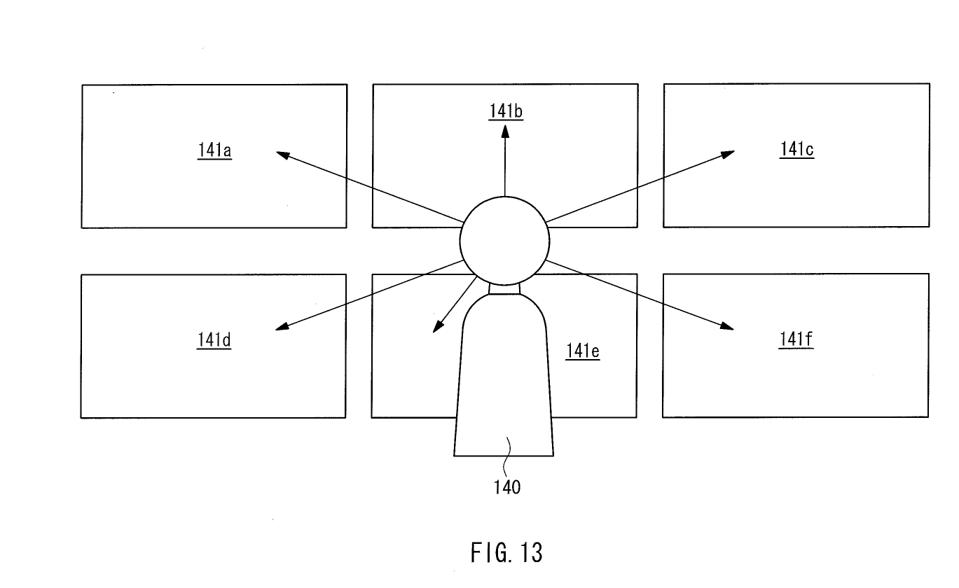

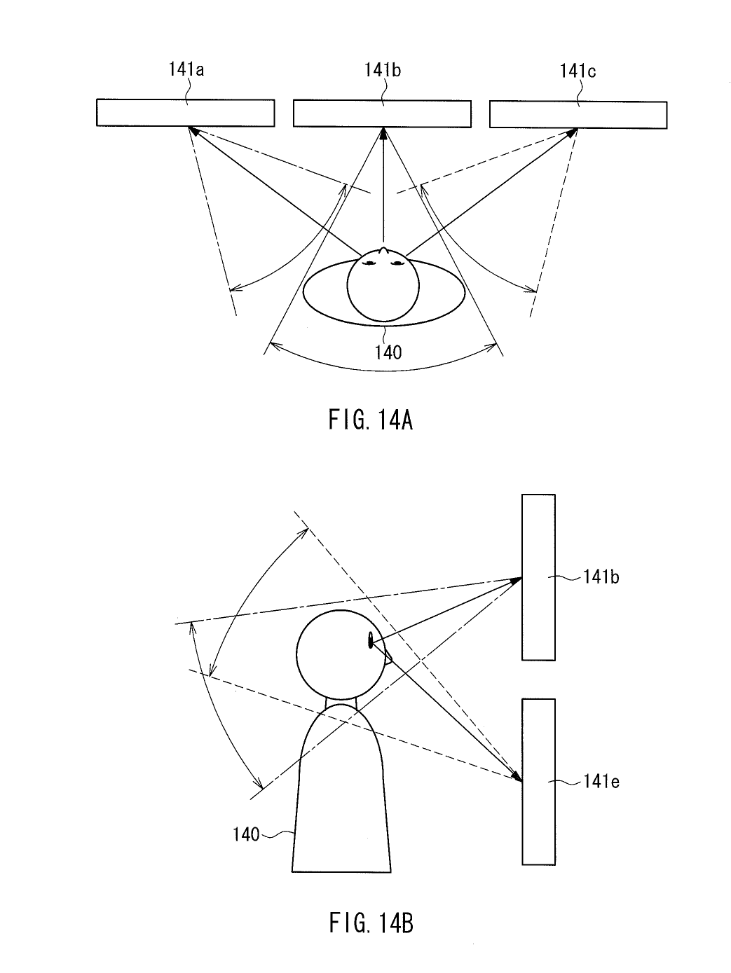

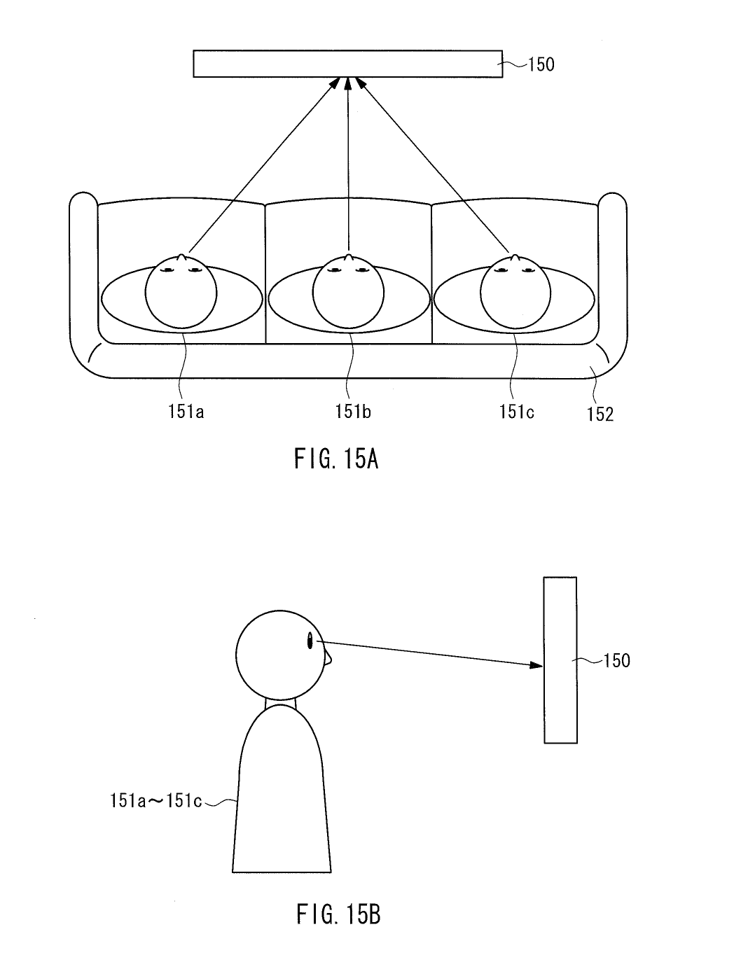

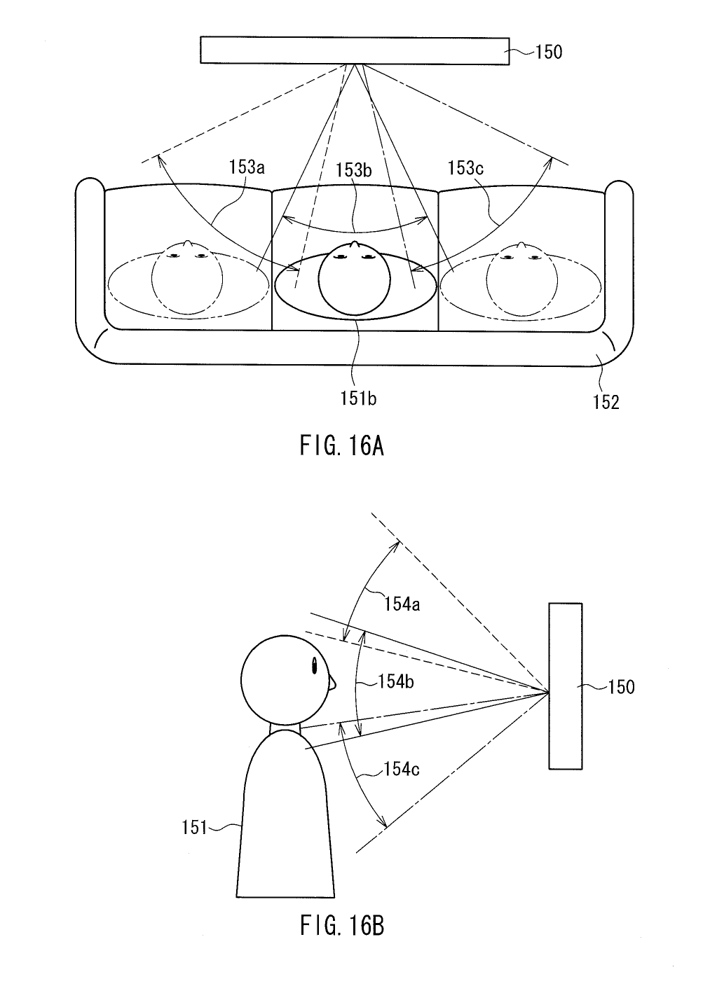

FIG. 9 is a cross-sectional view showing a display device 51 provided to an organic EL television according to a third embodiment of the present invention. Since the appearance of the organic EL television in the present embodiment is the same as that shown in FIG. 1, it is not mentioned here or not shown in the attached drawings. In FIG. 9, the lateral direction of the paper sheet corresponds to the vertical direction of the liquid crystal television, and an arrow 90 indicates the upward direction.

The display device 51 is formed of an organic EL panel 52 for display and a control panel 2. The control panel 2 is placed closer to the viewer than the organic EL, panel 52.

The organic EL panel 52 is formed of a TFT substrate 53, an organic ET, film 54 and a sealing substrate 55. There is no particular limitation for the details of the constitutions of the respective components of the organic EL, panel 52. For example, a known organic EL panel can be used.

The control panel 2 is formed of a first liquid crystal lens 5 that controls the vertical directivity and a second liquid crystal lens 6 that controls the lateral directivity. The constitution of the control panel 2 is the same as that of the control panel 2 as mentioned in the first embodiment. In FIG. 9, the components identical to those in FIG. 2 are assigned with the same reference numbers in order to avoid duplicated explanation.

As mentioned above, by placing the control panel 2 closer to the viewer than the organic EL panel 52 that is a light-emitting display, the directivity of light (viewing angle) in the vertical and horizontal directions can be controlled. For example, it is possible to switch a wide directivity (wide viewing angle) required at the shopfront for example and a narrow directivity (narrow viewing angle) required at home for example, and furthermore, it is possible to change the range of the narrow directivity (or the direction) in accordance with the visual angle of a detected viewer. When a narrow directivity is selected, since the light emitted from the organic EL panel 52 in an unnecessary direction is made to travel in a required direction, the light utilization efficiency is improved and the brightness of the screen is improved. If the amount of luminescence of the organic LE panel 52 is decreased instead of improving the brightness of the screen, the power consumption can be reduced. Furthermore, by decreasing the amount of luminescence, the life of the organic EL panel 52 can be extended.

In the present invention, for the control panel to control the directivity of light, the control panel 33 explained in the second embodiment can be employed instead of the control panel 2 explained in the first embodiment.

In the present embodiment, there is no particular limitation for the method of detecting the visual angle, and any of the methods explained in the first and second embodiments can be selected suitably.

The organic EL panel 52 may be replaced by any other light-emitting display such as PDP.

In the above-mentioned first to third embodiments, control panels using light refraction were used for the control panels to control the directivity of light. The present invention is not limited thereto but a control panel using optical diffraction may be used for example. For example, the control panel of the present invention can be provided by applying a liquid crystal lens using optical diffraction as described in Patent document 3.

### INDUSTRIAL APPLICABILITY

The present invention can be applied without any particular limitations to various kinds of thin film display devices for which reduction in power consumption is required. The display panel used in such a display device is not limited to a liquid crystal panel but a light-emitting panel such as an organic EL panel also may be used.

### EXPLANATION OF LETTERS AND NUMERALS

1,31,51 display device

2,33 control panel

3 liquid crystal panel for display

4 backlight

5,6 liquid crystal lens

7,23 polarizing plate

8,14 flat glass plate

9,15 grooved glass plate

10,16 flat electrode

11,17 chevron electrode

12,19,28 liquid crystal

13,18,22 sealant

20 TFT substrate (for liquid crystal)

21 counter substrate

24 light source

25 cabinet

26 scattering plate

27 selective polarization-reflection plate

34,35 directive film

36,37,38,39 sheet

40,41 roller

52 organic EL panel for display

53 TFT substrate (for organic EL)

54 organic EL film

55 sealing substrate

60a,60b infrared receiving unit

61a,61b CCD camera

1. A display device comprising:
a display panel that displays an image;
a control panel that controls directivity of light; and
a visual angle detector that detects a visual angle formed by a surface of the display panel and a visual line of a viewer,
wherein the control panel controls the directivity of light on the basis of the visual angle detected by the visual angle detector.

2. The display device according to claim 1, wherein the visual angle detector detects the visual angle on the basis of information provided by a remote-control.

3. The display device according to claim 1, wherein the visual angle detector detects the visual angle on the basis of a picture taken with a camera.

4. The display device according to claim 1, wherein the control panel comprises a liquid crystal lens.

5. The display device according to claim 1, wherein the control panel comprises a plurality of directive films.

6. The display device according to claim 1, wherein the display panel is a liquid crystal panel.

7. The display device according to claim 1, wherein the display panel is an organic EL panel.
